(19) United States
(12) Patent Application Publication
(10) Pub. No.: US 2023/0096608 A1
(43) Pub. Date: Mar. 30, 2023

(54) FIELD OF VIEW LASER POWER REBALANCING

(71) Applicant: Seagate Technology LLC, Fremont, CA (US)

(72) Inventor: Eric James Dahlberg, Eden Prairie, MN (US)

(21) Appl. No.: 17/865,608

(22) Filed: Jul. 15, 2022

Related U.S. Application Data
(60) Provisional application No. 63/217,872, filed on Jul. 2, 2021.

(51) Int. Cl. G01S 7/486; G01S 7/4865; G01S 17/10

(52) U.S. Cl. CPC G01S 7/4868; G01S 7/4865; G01S 17/10

(57) ABSTRACT

Method and apparatus for enhancing resolution in a light detection and ranging (LiDAR) system. A region of interest is identified within a baseline field of view (FoV), and an emitter is adjusted to apply an enhanced amount of electromagnetic radiation to the region of interest. A detector is used to identify at least one target in the region of interest. A common light source can be used to both illuminate the baseline FoV as well as supply the enhanced energy to the region of interest. Different energy densities can be supplied to the respective areas. A total energy output from the emitter can remain constant so that more power is directed to the region of interest, or energy output from the emitter can be increased to maintain the same energy density to the rest of the baseline FoV.

### RELATED APPLICATION

The present application makes a claim of domestic priority to U.S. Provisional Patent Application No. 63/217,872 filed Jul. 2, 2021, the contents of which are hereby incorporated by reference.

### SUMMARY

Various embodiments of the present disclosure are generally directed to an apparatus and method for rebalancing a field of view (FoV) of an active light detection system.

Without limitation, some embodiments operate to identify a region of interest within a baseline FoV, and an emitter is adjusted to apply an enhanced amount of electromagnetic radiation to the region of interest. A detector is used to identify at least one target in the region of interest responsive to the enhanced amount of electromagnetic radiation applied to the region of interest. A common light source can be used to both illuminate the baseline FoV as well as supply the enhanced energy to the region of interest. Different energy densities can be supplied to the respective areas. A rotatable polygon, micromirrors, galvanometers, and/or solid state array mechanisms can be used to divert the pulses to the region of interest.

These and other features and advantages of various embodiments disclosed herein can be understood from the following detailed description in conjunction with a review of the accompanying drawings.

### BRIEF DESCRIPTION OF THE DRAWINGS

FIG. 1 is a block representation of a Light Detection and Ranging (LiDAR) system constructed and operated in accordance with various embodiments of the present disclosure.

FIG. 2 is a simplified functional representation of an emitter constructed and operated in accordance with some embodiments.

FIGS. 3A-3C show different output systems that can be incorporated into an emitter such as in FIG. 2.

FIG. 4 is a simplified functional representation of a detector constructed and operated in accordance with some embodiments.

FIG. 5 depicts a field of view (FoV) of the system in some embodiments depicting various regions of interest.

FIG. 6 is a functional block representation of the system in some embodiments in which selected regions of interest are identified and adjustments are made accordingly.

FIG. 7 depicts a baseline FoV obtained by some embodiments.

FIG. 8 depicts an enhanced FoV with an embedded region of interest in accordance with some embodiments.

FIG. 9 shows a transmission and decoding sequence of pulses by various embodiments.

FIG. 10 depicts different baseline and enhanced pulses that can be emitted and processed by various embodiments.

FIG. 11 is a flow diagram for an enhanced resolution scan sequence carried out in accordance with some embodiments.

FIG. 12 depicts an adaptive scan window management system constructed and operated in accordance with further embodiments.

### DETAILED DESCRIPTION

Various embodiments of the present disclosure are generally directed to optimization of an active light detection system.

Light Detection and Ranging (LiDAR) systems are useful in a number of applications in which ranges (e.g., distances) from an emitter to a target are detected by irradiating the target with electromagnetic radiation in the form of light. The range is detected in relation to timing characteristics of reflected light received back by the system. LiDAR applications include topographical mapping, guidance, surveying, and so on. One increasingly popular application for LiDAR is in the area of autonomously piloted or driver assisted vehicle guidance systems (e.g., self driving cars, autonomous drones, etc.). While not limiting, the light wavelengths used in a typical LiDAR system may range from ultraviolet to near infrared (e.g., 250 nanometers, nm to 1000 nm or more). Other wavelength ranges can be used.

One commonly employed form of LiDAR is sometimes referred to as coherent pulsed LiDAR, which generally uses coherent light and detects the range based on detecting phase differences in the reflected light. Such systems may use a dual (IQ) channel detector with an I (in-phase) channel and a Q (quadrature) channel. Other forms of LiDAR systems can be used, however, including non-coherent light systems that may incorporate one or more detection channels. Further alternatives that can be incorporated into LiDAR systems include systems that sweep the emitted light using mechanical based systems that utilize moveable mechanical elements, solid-state systems with no moving mechanical parts but instead use phase array mechanisms to sweep the emitted light in a direction toward the target, and so on.

While operable, these and other forms of LiDAR systems can have difficulty providing accurate detection resolution in all desired areas under all operating conditions. In particular, it may be desirable at times to provide enhanced detection to particular regions of interest within the field of view (FoV) of the system.

Various embodiments of the present disclosure are accordingly directed to a method and apparatus for providing enhanced detection capabilities in a LiDAR system. As explained below, some embodiments provide a processing sequence (e.g., algorithm) for automatically adjusting the laser output level or fire rate based on a region of interest priority scheme. In this way, enhanced detection response can be provided. The adjustments can be automatic or user selected, as desired.

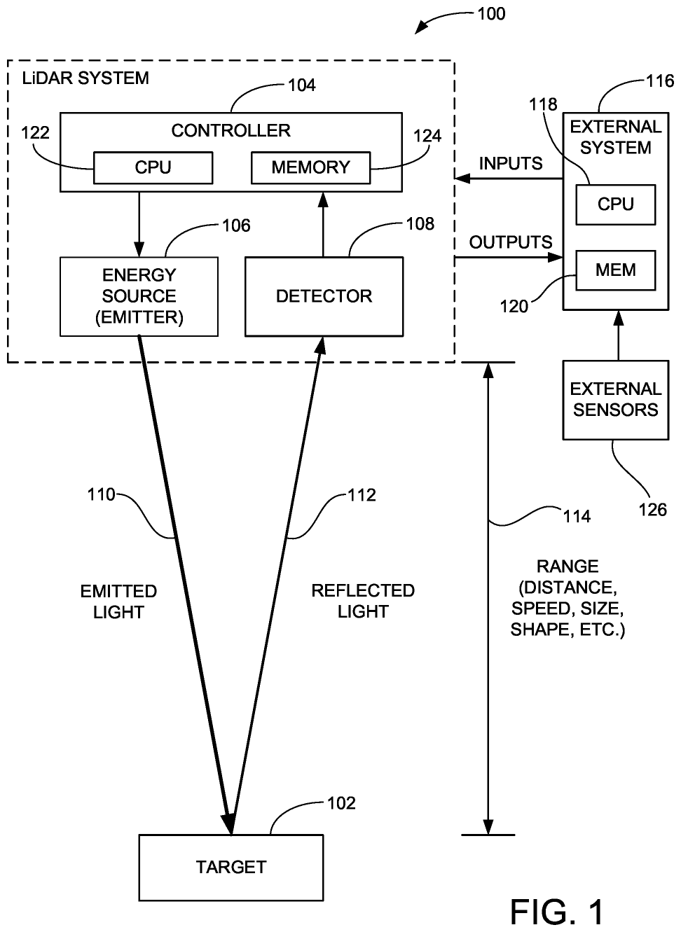

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

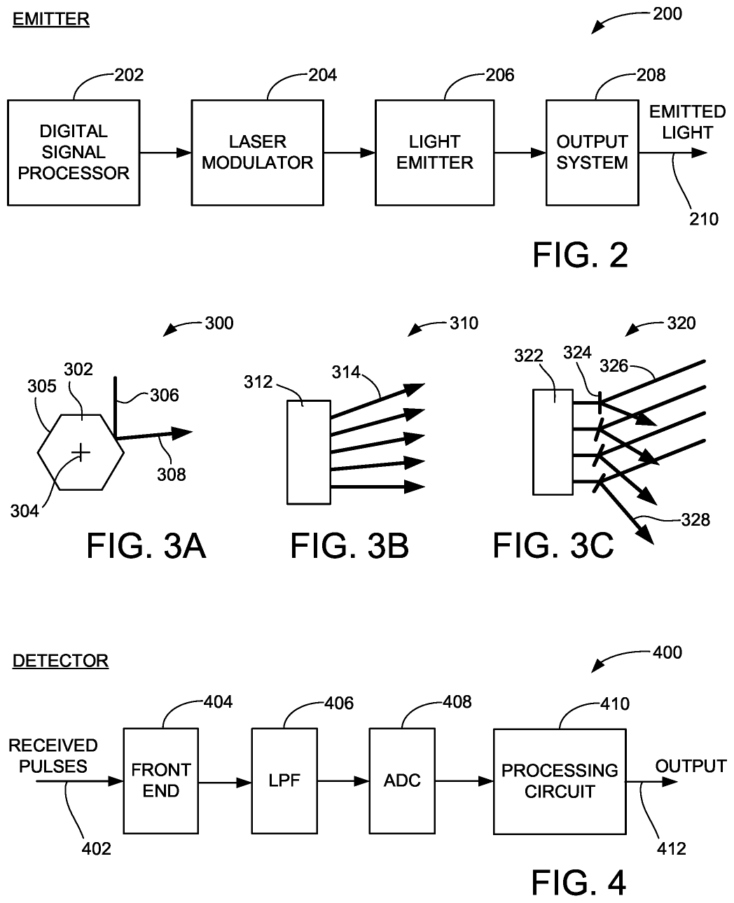

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter (e.g., a laser, a laser diode, etc.) that emits electromagnetic radiation (e.g. light) in a desired spectrum. The emitted light is processed by an output system 208 to issue a beam of emitted light 210. The light may be in the form of pulses, coherent light, non-coherent light, swept light, etc.

FIGS. 3A-3C show different aspects of some forms of output systems that can be used by the system of FIG. 2. Other arrangements can be used. FIG. 3A shows a system 300 that includes a rotatable polygon 302 which is mechanically rotated about a central axis 304 at a desired rotational rate. The polygon 302 has reflective outer surfaces 305 adapted to direct incident light 306 as a reflected stream 308 at a selected angle responsive to the rotational orientation of the polygon 302. The polygon is characterized as a hexagon with six reflective sides, but any number of different configurations can be used. By coordinating the impingement of light 306 and rotational angle of the polygon 302, the output light 308 can be swept across a desired field of view (FoV).

FIG. 3B provides a system 310 with a solid state array (integrated circuit device) 312 configured to emit light beams 314 at various selected angles across a desired FoV. Unlike the mechanical system of FIG. 3A, the solid state system of FIG. 3B has essentially no moving parts.

FIG. 3C shows another system 320 that employs a base substrate 322 that supports an array of micromirrors 324. Piezoelectric or other mechanisms can be used to deflect the micromirrors 324 and change an angle between incident light 326 and reflected light 328.

Regardless the configuration of the output system, FIG. 4 provides a generalized representation of a detector circuit 400 configured to process reflected light issued by the system of FIG. 2. The detector circuit 400 receives reflected pulses 402 which are processed by a suitable front end 404. The front end 404 can include optics, detector grids, amplifiers, mixers, and other suitable features to present input pulses reflected from the target. The particular configuration of the front end 404 is not germane to the present discussion, and so further details have not been included. It will be appreciated that multiple input detection channels can be utilized.

A low pass filter (LPF) 406 and an analog to digital converter (ADC) 408 can be used as desired to provide processing of the input pulses. A processing circuit 410 provides suitable signal processing operations to generate a useful output 412.

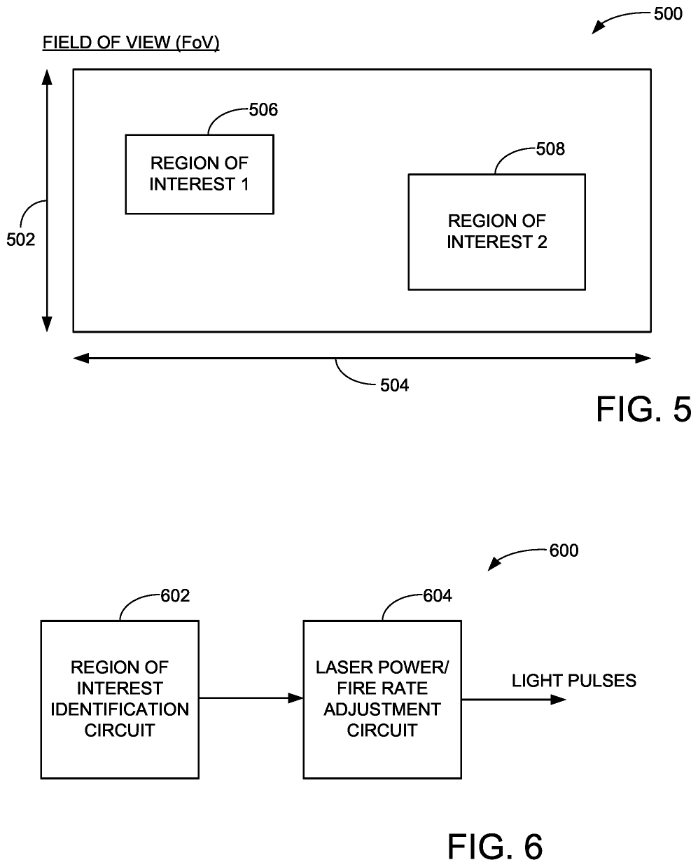

FIG. 5 shows a field of view (FoV) that may be represented as that portion of down range space that is accessed by the system 100. Without limitation since different coordinate and spatial dimensions can be used, the FoV 500 is described as having a width 502 and a height 504. Other terms can be used (e.g., azimuth, etc.).

Within the FoV are denoted selected regions of interest, such as regions 1 and 2, represented at 506 and 508. These regions of interest can be any selected areas. For example, in the context of a projectile, a region of interest may be calculated as an area into which the object with which the system is associated is expected to penetrate in the near future. In the context of a vehicle, a region of interest may be locations where important information may appear (e.g., road signs, pedestrians, etc.). Substantially any subset of an overall FoV may be deemed a region of interest, and this may change at different times under different circumstances. In some cases, system inputs may trigger the focusing of the system on particular areas as a region of interest. In this way, the context of a region of interest is not necessarily a fixed location within the FoV, but rather, may be time and circumstance dependent.

FIG. 6 shows a processing circuit 600 of the system 100 in some embodiments. The processing system provides closed loop interaction between an emitter (such as in FIG. 2) and a detector (such as in FIG. 4) of the system. The circuit 600 includes a region of interest identification circuit 602. This circuit can operate as described above to identify a particular region of the FoV (e.g., 500) at a particular point in time. In response to the detection of one or more regions of interest, an adjustment circuit 604 operates to make adjustments to the emitter and, as necessary, adjustments to the detector of the system. In at least some embodiments, the adjustment circuit 604 operates to adjust laser power and/or fire rate of the emitter at least in the regions of interest to enhance detection of the system.

In some embodiments, greater and or higher power is applied to the emitter to scan the region of interest. In other embodiments, adjustments are made so that a greater percentage than normal of the available scanning is supplied to the region of interest (e.g., the beams emitted by the system are directed to spend more time or provide greater amounts of power upon the selected region). In still other embodiments, pulse rates are increased so that relatively more pulses are directed toward target(s) in the region of interest.

In this way, a region of interest can be identified based on various inputs (including automated inputs or user selected inputs) and greater focus is applied to the region(s) of interest in detecting range information for target(s) that may appear in such regions of interest.

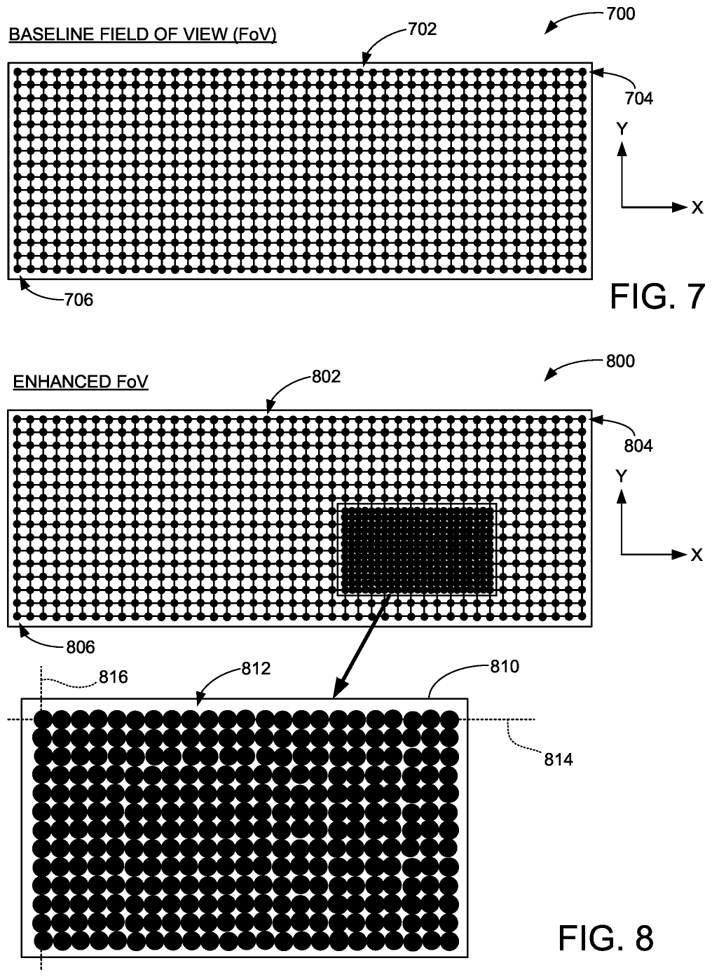

FIG. 7 shows a baseline field of view (FoV) 700 representative of the operation of the system as described above in accordance with some embodiments. More particularly, the FoV 700 is a target window of the surrounding environment illuminated by and detected by the system. It will be appreciated that the FoV 700 is greatly simplified, but nonetheless serves to provide a basic description of the operation of the system.

The FoV 700 is spanned by beam points 702 that are rasterized along respective orthogonal directions x and y so as to be arranged along rows 704 and columns 706. In some embodiments, the beam points 702 are issued as pulses that rasterize, or scan, the entirety of the window of the FoV such as along each row in turn. A complete scanning of the entirety of the window is referred to as a frame. Many such frames are obtained over each unit of time (e.g., many frames are obtained per second, etc.).

Depending on the configuration of the system, there will be many more beam points 702 supplied along each row 704 and column 706 than those shown in FIG. 7 in each frame. Any suitable rasterization pattern can be used, such as each row in turn, each column in turn, reversals, segmented patterns, circular/rectangular patterns, etc. Multiple beam sources and output devices (see e.g., FIGS. 3A-3C) can be used to illuminate the window shown in FIG. 7.

Regardless, in general FIG. 7 shows that, during a baseline mode of operation, substantially a uniform amount of energy is distributed across the entirety of the window defined by the FoV 700. Targets within the window (not separately represented in FIG. 7) will provide reflected light that can be processed by a detector such as the detector 400 in FIG. 4 as described above.

FIG. 8 shows an enhanced FoV 800 in accordance with further embodiments. The enhanced FoV 800 is similar to the baseline FoV 700 in FIG. 7 in some respects, including the fact that the window is illuminated as before by beam points 802 rasterized in orthogonal x-y directions along rows 804 and columns 806.

A particular region of interest is identified as area (FoV) 810, which defines a subset of the overall FoV 800. The FoV 810 is similarly rasterized by beam points 812. The points 812 are arranged along rows 814 and columns 816 arranged along the orthogonal x-y axes as before, although such is not necessarily required. It can be seen that the FoV 810 has a significantly higher density and resolution as compared to the baseline FoV 810 (and FoV 700 in FIG. 7).

The FoV 810 may also be subjected to a higher frame rate as compared to the FoV 700/800, so that not only are the beams 812 closer together (e.g., there is a greater density of rows and columns in FoV 810), but the cyclical rasterization of the beams 812 may be at a higher rate as compared to the beams 702, 802 as well. In this way, greater amounts of energy are directed to the FoV 810 by the system to track, with greater resolution, targets disposed within this enhanced window.

In some cases, the beam points 702 and 802 within the baseline areas of FoVs 700, 800 are nominally identical to the beam points 812 within enhanced FoV 810; that is, all of these respective beams can have nominally the same frequency, wavelength, amplitude, pulse count, timing, duration, and so on. The difference in this case is that the beams supplied to the enhanced FoV area 810 are simply more dense than in other areas within the rest of the FoV. Stated another way, more pulses are directed into the area 810 as compared to the rest of the area 800 (and the area 700).

In other cases, differences are supplied in terms of waveform characteristics provided to the enhanced FoV area 810 as compared to the baseline pulses supplied to the rest of the FoV area 700/800. In this way, significantly greater amounts of energy can be diverted to the enhanced FoV area 810. In still further cases, a reduction can be made in the average energy density to the rest of area 800 not included within area 810 so that fewer and/or lower energy pulses are provided to areas of lesser interest while the energy is directed to the area of greater interest.

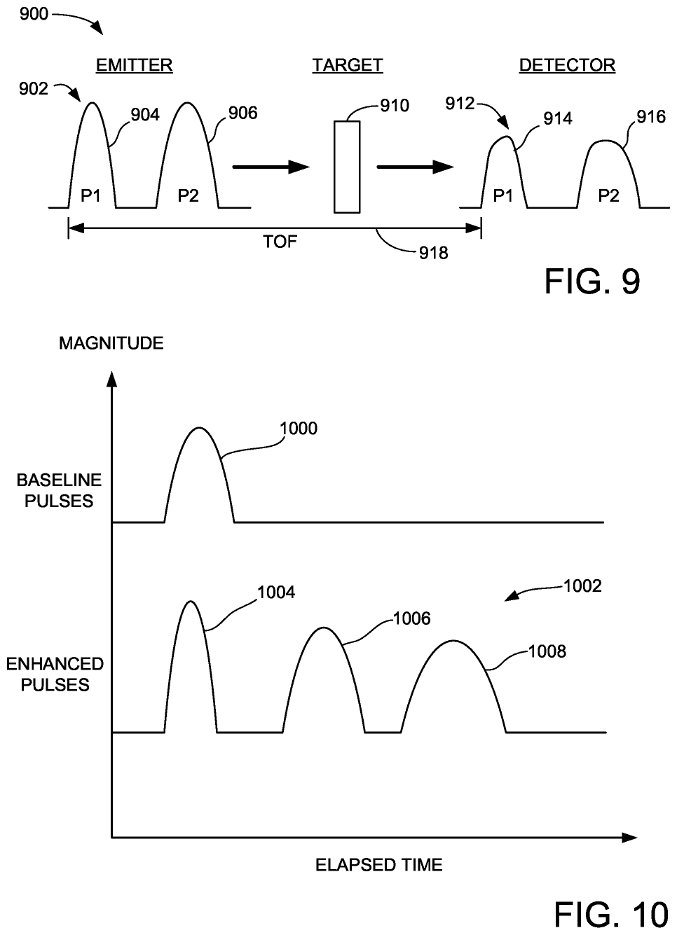

FIG. 9 shows a transmission and reception sequence 900 of pulses that can be generated and processed by the system in accordance with some embodiments. An initial set of pulses is depicted at 902 having two pulses 904, 906 denoted as P1 and P2. Each pulse may be provided with a different associated frequency or have other characteristics to enable differentiation by the system. The emitted pulses 904, 906 are quanta of electromagnetic energy that are transmitted downrange toward a target 910 within the associated FoV (e.g., FIGS. 5, 7-8).

Reflected from the target is a received set of pulses 912 including pulses 914 (pulse P1) and 916 (pulse P2). The time of flight (TOF) value for pulse P1 is denoted at 918. Similar TOF values are provided for each pulse in turn. Range information including distance and other parameters can be calculated responsive to the TOF values of the respective pulses.

The received P1 pulse 914 may undergo frequency doppler shifting and other distortions as compared to the emitted P1 pulse 904. The same is generally true for each successive sets of transmitted and received pulses such as the P2 pulses 906, 916. In some cases, this detected doppler shift information can be used to provide range information, such as but not including relative velocity between the target and the emitter, etc. Regardless, the frequencies, phase and/or amplitudes of the received pulses 914, 916 will be processed as described above to enable the detector circuit to correctly match the respective pulses and obtain accurate distance and other range information.

FIG. 10 provides a graphical representation of emitted pulse sequences that can be used by various embodiments. A first pulse 1000 represents normal pulses that are emitted by the emitter of the system. This first pulse will have various waveform characteristics including frequency, wavelength, duration, period, amplitude, phase, etc. These pulses 1000 can be issued as single pulses or multiple pulses in a set. The pulses 1000 can generate the various baseline beam points described above to rasterize an overall FoV, such as but not limited to the FoVs shown in FIGS. 5, 7 and 8.

FIG. 10 further shows an enhanced pulse set 1002. The enhanced pulse set 1002 can be used to illuminate the selected areas of interest, such as the area 810 in FIG. 8. One or more pulses can be supplied in the enhanced pulse sets, as depicted by the respective pulses 1004, 1006 and 1008. These pulses are each provided with their own waveform characteristics, and these may be different from one another as well as different from the baseline pulses 1000.

Because the area of interest is provided with greater levels of energy and decoding resources, it may be advantageous in some applications to provide a broad spectrum range of wavelengths, amplitudes and phase shifts to the pulses supplied in order to obtain the desired granularity of range information for targets therewithin. While a single pulse is shown for normal operation and multiple pulses are shown for enhanced operation, such is merely exemplary of some embodiments and is not limiting. In other embodiments, the same number and types of pulses can be provided to both the baseline and enhanced FoV areas, with a greater frame rate, density, amplitude, or other factor being used to direct a higher average energy level to the enhanced area (e.g., 810) as compared to the baseline area (e.g., 700 or 800 outside area 810).

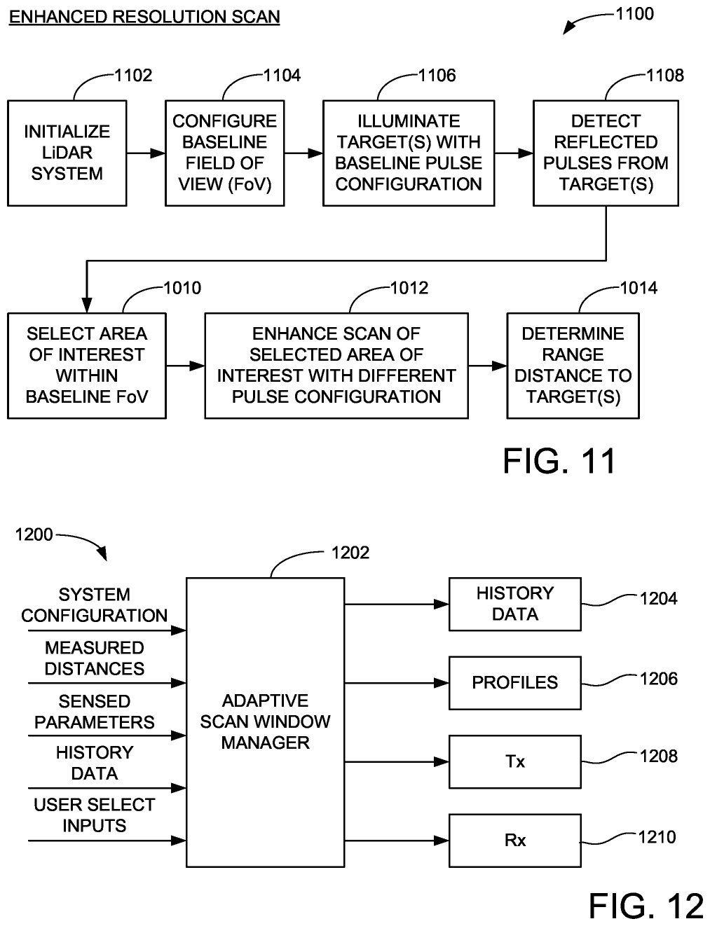

FIG. 11 is a sequence diagram 1100 for an enhanced resolution scan operation carried out in accordance with various embodiments described herein. Other operational steps can be incorporated into the sequence as required, so the diagram is merely illustrative and is not limiting.

A LiDAR system such as 100 in FIG. 1 is initialized at block 1102. An initial, baseline field of view (FoV) is selected for processing at block 1104. This will include selection and implementation of various parameters (e.g., pulse width, wavelength, raster scan information, density, etc.) to accommodate the baseline FoV.

The system commences with normal operation at block 1106. This can include scans of the baseline FoV as depicted in FIG. 7. Light pulses are transmitted to illuminate various targets within the FoV as described above using the emitters as variously described in FIGS. 1-2 and 6. The light pulses can be rasterized along various orthogonal axes to cover the FoV window.

Reflected pulses from various targets within the baseline FoV will be detected by a detector such as depicted in FIGS. 1 and 4, as denoted by the operation of block 1108. Various operations can be carried out as a result of the detected range information obtained from the baseline FoV.

At some point during continued operation of the system, an area of interest within the baseline FoV will be identified as shown by block 1010. The size, location and distance of the enhanced area, also referred to as an enhanced FoV, will depend on the requirements of a given application. For example, during detected high speed travel conditions (such as indicated by other sensors such as a GPS, a speedometer, etc.), it may be desirable to provide a long range scan window in the central portion of the baseline FoV to detect high speed vehicles or other elements that may be of interest. Other situations will readily occur to the skilled artisan where an enhanced field of interest (enhanced FoV) may be selected.

Once selected, the enhanced FoV is subjected to enhanced scan energies at block 1012. This can include a higher density of beam points, different frequencies, amplitudes, pulse counts, etc. In some cases, pulses that would have otherwise been dedicated to the rest of the baseline FoV can be instead diverted to the enhanced FoV While it is contemplated that a single source will be utilized to provide the beams in both the baseline FoV and the enhanced FoV, in further embodiments additional sources can be brought online to provide the enhanced FoV scanning.

Regardless of the manner in which the system is adaptively configured, the enhanced FoV receives enhanced scanning resolution. In response, the optical element Range information for targets detected within the enhanced area is obtained during block 1014 and processed accordingly. In some embodiments, range information associated with the baseline scan can be used to implement the enhanced scan operation of blocks 1010-1014. In other embodiments, range information associated with the enhanced scan (including lack thereof of any particularly useful information) can be used to transition the system back to baseline scanning without the additional scanning of the enhanced FoV. Other operational configurations will readily occur to the skilled artisan in view of the foregoing discussion.

As noted above, the system can cycle to provide different scanning patterns for different areas as required. FIG. 12 shows an adaptive scan window resolution management system 1200 that can be incorporated into the system 100 of FIG. 1 in some embodiments. The system 1200 includes an adaptive scan window manager circuit 1202 which operates to implement the enhanced resolution scans in the selected fields of interest within a baseline FoV as described above. The manager circuit 1202 can be incorporated into the controller 104 such as a firmware routine stored in the local memory 124 and executed by the controller processor 122.

The manager circuit 1202 uses a number of inputs including system configuration information, measured distance for various targets, various other sensed parameters from the system (including external sensors 126), history data accumulated during prior operation, and user selectable inputs. Other inputs can be used as desired.

The manager circuit 1202 uses these and other inputs to provide various outputs including accumulated history data 1204 and various profiles 1206, both of which can be stored in local memory such as 124 for future reference. The history data 1204 can be arranged as a data structure providing relevant history and system configuration information. The profiles 1206 can describe different pulse set configurations with different numbers of pulses at various frequencies and other configuration settings, as well as other appropriate gain levels, ranges and slopes for different sizes, types, distances and velocities of detected targets.

The manager circuit 1202 further operates to direct various control information to an emitter (transmitter Tx) 1208 and a detector (receiver Rx) 1210 to implement these respective profiles. It will be understood that the Tx and Rx 1208, 1210 correspond to the various emitters and detectors described above. Without limitation, the inputs to the Tx 1208 can alter the pulses being emitted in the area of interest (including actuation signals to selectively switch in the specially configured lens or other optical element), and the inputs to the Rx 1210 can include gain, timing and other information to equip the detector to properly decode the pulses from the enhanced resolution area of interest.

As described previously, different gain ranges can be selected and used for different targets within the same FoV. Closer targets within the point cloud can be provided with one range with a lower slope and magnitude values to obtain optimal resolution of the closer targets, while at the same time farther targets within the point cloud can be provided with one or more different gain ranges with higher slopes and/or different magnitude values to obtain optimal resolution of the farther targets. It will be noted that the baseline scan can be maintained at a constant level with variable scans switched into operation over substantially any subset area of the baseline scan, including but not limited to substantially all of the baseline FoV, at least for limited periods of time.

Energy budget issues can be a concern, so that the energy supplied to the enhanced scanning can be carried out for a selected period of time (e.g., 10 minutes, etc.), after which the system defaults to normal baseline scanning. Events can be used as triggers to enhance the scans, such as the detection of relatively high velocity targets or targets that may have a calculated trajectory that is of concern, at which time the system can implement the enhanced scanning techniques described above until such time that the need for continued scanning is deemed to be passed.

It can now be understood that various embodiments provide a LiDAR system with the capability of emitting light pulses over a selected FoV, along with a specially configured enhancement feature that, when switched into the system, directs at least some of the energy from the emitter into a reduced sized area of interest within the FoV with a corresponding aspect of range. Any number of different alternatives will readily occur to the skilled artisan in view of the foregoing discussion.

While coherent, I/Q based systems have been contemplated as a basic environment in which various embodiments can be practiced, such are not necessarily required. Any number of different types of systems can be employed, including solid state, mechanical, galvanometer based systems, micromirror arrangements, rotatable polygons, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method for detecting targets using a light detection and ranging (LiDAR) system, comprising:
identifying a region of interest as a subset of a field of view (FoV) of the LiDAR system;
adjusting an emitter of the LiDAR system to apply an enhanced amount of electromagnetic radiation to the region of interest; and
using a detector of the LiDAR system to discern at least one target in the region of interest responsive to the enhanced amount of electromagnetic radiation applied to the region of interest.

2. The method of claim 1, wherein a light source of the emitter is used to scan the FoV at a first energy density, and wherein a total amount of energy output by the light source is not substantially changed as a greater amount of the energy output is directed to the region of interest and a second, lower energy density is provided to remaining portions of the FoV outside the region of interest.

3. The method of claim 1, wherein a light source of the emitter is used to scan the FoV at a first energy density, and wherein a total amount of energy output by the light source is increased so that the emitter continues to scan remaining portions of the FoV outside the region of interest at nominally the first energy density while a greater, second energy density is applied by the light source of the emitter to the region of interest.

4. The method of claim 1, wherein the adjusting step is carried out responsive to range information obtained from a target within the FoV illuminated by the electromagnetic radiation from the emitter.

5. The method of claim 1, wherein the adjusting step is carried out responsive to an input supplied by an external sensor and independently of range information obtained from a target within the FoV illuminated by the electromagnetic radiation from the emitter.

6. The method of claim 1, wherein the electromagnetic radiation emitted by the emitter is in the form of baseline pulses having a first set of waveform characteristics, the baseline pulses rasterized across the FoV along orthogonal axes, and wherein the region of interest is rasterized along said orthogonal axes using enhanced pulses of electromagnetic radiation from the emitter having a different, second set of waveform characteristics.

7. The method of claim 6, wherein the FoV outside the region of interest is rasterized at a first frame rate, and the region of interest is rasterized at a higher, second frame rate.

8. The method of claim 1, wherein a first number of pulses are transmitted by the emitter over the FoV outside the region of interest per unit area over a selected time period, and wherein a higher second number of pulses are transmitted by the emitter within the region of interest per unit area over the selected time period.

9. The method of claim 1, wherein an output system is used to respectively direct a light beam from the emitter over the FoV and the region of interest.

10. The method of claim 9, wherein the output system comprises at least a selected one of a rotatable polygon, a solid-state array device, a micromirror device or a galvanometer.

11. The method of claim 1, wherein a controller circuit operates responsive to an activation signal to switch in enhanced irradiation of the region of interest within the FoV.

12. An apparatus comprising:
an emitter of a LiDAR system configured to emit light pulses at a first resolution over a baseline field of view (FoV);
a controller circuit configured to identifying a region of interest as a subset of the FoV and to direct the emitter to apply an enhanced amount of electromagnetic radiation to the region of interest at a higher, second resolution; and
a detector configured to discern a first target in the region of interest responsive to the enhanced amount of electromagnetic radiation applied to the region of interest.

13. The apparatus of claim 12, wherein the detector is further configured to discern a second target within the baseline FoV, and wherein the controller circuit identifies the region of interest responsive to the detected second target by the detector.

14. The apparatus of claim 12, wherein a light source of the emitter is used to scan the baseline FoV at a first energy density, and wherein a total amount of energy output by the light source is not substantially changed as a greater amount of the energy output is directed to the region of interest and a second, lower energy density is provided to remaining portions of the FoV outside the region of interest.

15. The apparatus of claim 12, wherein a light source of the emitter is used to scan the baseline FoV at a first energy density, and wherein a total amount of energy output by the light source is increased so that the emitter continues to scan remaining portions of the baseline FoV outside the region of interest at nominally the first energy density while a greater, second energy density is applied by the light source of the emitter to the region of interest.

16. The apparatus of claim 12, wherein the controller circuit identifies the region of interest in response to an input supplied by an external sensor and independently of range information obtained from a target within the baseline FoV illuminated by the light pulses from the emitter.

17. The apparatus of claim 12, wherein the light pulses emitted by the emitter across the baseline FoV have a first set of waveform characteristics, and wherein the emitter further emits light pulses that scan the region of interest with a different, second set of waveform characteristics.

18. The apparatus of claim 17, wherein the FoV outside the region of interest is rasterized at a first frame rate, and the region of interest is rasterized at a higher, second frame rate.

19. The apparatus of claim 12, wherein a first number of pulses are transmitted by the emitter to cover the baseline FoV outside the region of interest per unit area over a selected time period, and wherein a higher second number of pulses are transmitted by the emitter within the region of interest per unit area over the selected time period.

20. The apparatus of claim 12, wherein an output system is used to respectively direct a light beam from the emitter over the FoV and the region of interest, the output system comprising at least a selected one of a rotatable polygon, a solid-state array device, a micromirror device or a galvanometer.
